(19) United States
(12) Patent Application Publication
(10) Pub. No.: US 2007/0073597 A1
(43) Pub. Date: Mar. 29, 2007

(54) Method and System for a Customer to Place an Order with a Human Order Taken in a Customer-Selected Language

(76) Inventor: Alexander McLain Grubbs, Chapel Hill, NC (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/530,740

(22) Filed: Sep. 11, 2006

(51) Int. Cl. G06Q 30/00

(52) U.S. Cl. 705/26

(57) ABSTRACT

A method and system for a customer to orally place an order with a human order taker permits the customer to select the language in which the order is placed. The system receives a signal reflective of the customer's choice of language and, based on this signal, connects the customer using Voice Over IP (VOIP) technology to a human order taker suitably conversant in the customer-selected language. The human order taker typically is situated in a location other than at the establishment at which the customer is placing the order. Additional information may be sent over the same IP link to provide the human order taker the same, or similar information available to an order taker present at the establishment. This system is intended to reduce errors in orders orally placed by customers, such as in fast food drive through establishments.

### FIELD OF THE INVENTION

The present invention is directed to a system that allows a customer to speak in a language of the customer's choice to interface with human personnel, such as customer service representatives. Such a system facilitates voice communication and reduces the chances that information exchanged between the customer and the representative is misunderstood.

### BACKGROUND INFORMATION

A drive-thru restaurant typically has a first drive-thru section where a menu is located. At this first drive-thru section, the customer reads the menu and is verbally greeted by a human order taker via an intercom or other communication device, sometimes equipped with video. The human order taker is physically located in that same restaurant. The customer places his or her order with the human order taker and then proceeds to a second drive-thru section to pay a human cashier and pick up the ordered items. The person gathering the ordered food items may be a third individual who hands the items to the cashier. In some fast food establishments, one person may serve two of these three roles and in other establishments, the same person may serve all three roles, depending on the volume of customers and/or the time of day.

One problem that can arise in the ordering process is miscommunication due to either or both the customer and the order taker speaking in a language other than their native language. For instance, Spanish may be the customer's native language while English may be the order taker's native language. As a result, when the customer gives the order in English, there is a chance that the order taker may misinterpret the order, resulting in the customer receiving one or more wrong food items. What is needed is a system whereby a customer can speak to an order taker in a language of the customer's choice, to an order taker proficient in that customer-preferred language.

### SUMMARY OF THE INVENTION

In one aspect, the present invention is directed to method for taking an order from a customer visiting an establishment, the order being verbally placed by the customer in a language of the customer's choice. The method comprises receiving a first signal containing information reflective of a language in which the customer wishes to verbally place the order; connecting the customer to a human order taker situated at a location away from the establishment, the human order taker being proficient in said language in which the customer wishes to verbally place the order; and converting the customer's verbal order into an electronic order and providing the electronic order to the establishment.

In another aspect, the invention is directed to a customer-selected-language verbal ordering system. The system comprises a first center configured to receive a first signal containing information reflective of a language in which a customer visiting an establishment wishes to verbally place an order to obtain goods or services; the first center including a first computer having access to information comprising available human order takers situated in locations away from the establishment, language capabilities of each order taker, and routing information sufficient to establish a voice connection between the customer and a selected human order taker; the first computer further being provided with logic to automatically assign a human order taker capable of taking the customer's order in said language in which the customer wishes to verbally place the order.

### BRIEF DESCRIPTION OF THE DRAWINGS

The present invention is described with reference to the attached figures in which:

FIG. 1 presents a system in accordance with one embodiment of the present invention.

FIG. 2 presents a system in accordance with a second embodiment of the present invention.

FIG. 3 presents a flow chart depicting a method in accordance with the embodiment of FIG. 1.

FIG. 4 presents a flow chart depicting a method in accordance with the embodiment of FIG. 2.

### DETAILED DESCRIPTION

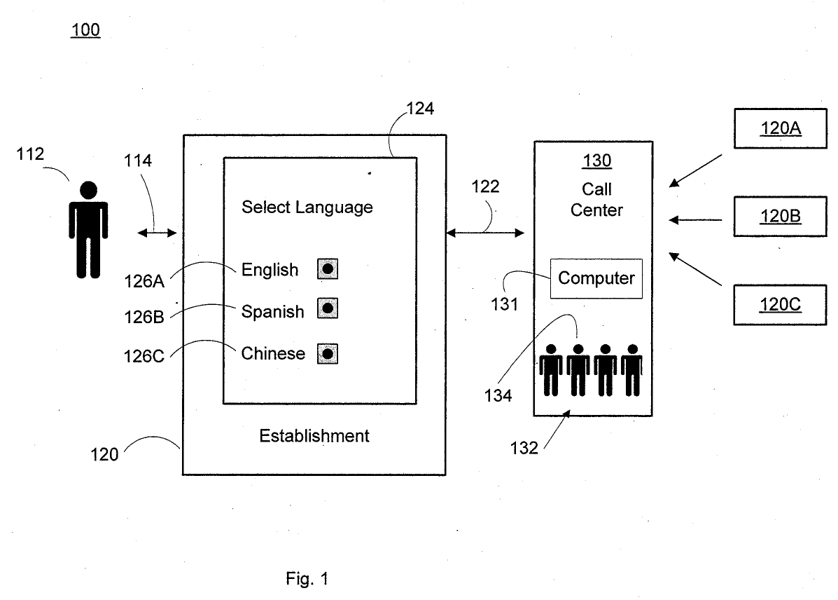

FIG. 1 shows a system 100 in accordance with one embodiment of the present invention. A customer 112 goes to the drive-thru at an establishment 120, such as a fast food restaurant 120, to place an order. At the first station, the customer views the menu as usual, and is also presented with an opportunity to select the language in which the order may be placed.

A display 124 informs the customer 112 in one or more languages that the customer may select a language in which the transaction may be conducted. In the embodiment of FIG. 1, the language choices include English 126A, Spanish 126B and Chinese 126C. In one embodiment, the display 124 comprises an electronic display with a touch screen, and the customer simply pushes a virtual button on the touch screen to make a language selection. In other embodiments, the display 124 may comprise a sign with a button associated with each language selection, and the customer depresses the button to make the language selection.

The customer 112 interfaces with the display 124 as represented by the double-headed arrow 114 and is given an opportunity to push a button corresponding to the selected language. Upon pushing a button, a first signal is created and sent to a call center 130 via communication link 122. This first signal is thus initiated at a station of the drive-thru.

The first signal comprises one or more data packets and may include information reflective of the selected language, an establishment identifier, a transaction identifier, and the IP address of the establishment 120, among other items.

The call center 130 is at a location other than at the fast food establishment 120. Almost invariably, this means that the call center 130 is not in the same building as the establishment 120. And while the call center 130 may be in the same city as the establishment 120, it may instead be in a different city, county, state, province, or even country than the establishment 120.

In one embodiment, the communication link 122 is established via the internet and is capable of carrying both voice and data. Such a link may be always open with minimal cost. In a preferred embodiment, the link 122 includes a voice-over-Internet-Protocol (VOIP) component and a data protocol component, such as http. In the embodiment of FIG. 1, the fast food establishment 120 is connected to a call center 130 via a communication link 122 that may be always open.

At the call center 130 are a plurality of human order takers 132. In general, the order takers will be hired based on their native language ability in addition to their ability to communicate in the commonplace language as a second-language. Some operators may have additional language skills and this would be noted in the call center status software program. In the event of unexpected overloading in a particular language, such information would allow routing of calls to multi-lingual operators.

Once the customer 112 pushes the button signifying a language selection, the customer is connected to the call center 130 via the communications link 122. More particularly, the customer is connected to an assigned order taker 134 who is sufficiently proficient in the selected language so as to take a customer's order in that selected language. The customer then places his or her order with the assigned order taker 134.

At the call center 130, the first signal is present to a call center computer 131. The call center computer 131 parses the signal into its components and various checks are made to validate the signal. Such checks may include encryption and data integrity codes, as well as a confirmation that the establishment has indeed contracted to have language services.

Another check may include looking up the defined level of service available to that establishment at that time. When an establishment contracts with the organization that owns and/or operates the call center, the establishment selects the mix of services to which it is entitled. One type of service level may be the variety of languages for which the establishment has contracted. Thus, while one establishment contracts for English and Spanish, another may contract for another combination of languages. Another type of service level may be the acceptable delay, or latency, in getting a human order taker to speak with the customer. One establishment might contract for no more than, say, a ten-second delay before a human order taker proficient in the customer-selected language is available. Another establishment on the other hand, may contract for a longer delay, such as minute or even longer, depending on its needs. Thus, for example, while a fast food restaurant may want its customers to wait no more than 10 seconds before being connected to a human order taker, a hospital's patient billing office may find it acceptable for its customers to be “on hold” for a minute, or even more. Yet another type of service level may be the proficiency of the human order takers or other human customer service agents. Thus, one establishment may insist that only ‘highly proficient’ speakers, as determined by testing or other means, be used. Other establishments may agree to have speakers with lesser proficiency and qualifications.

Once cleared as a valid request, the call center computer 131 then looks up to determine which of the order takers 132 are conversant in the selected language, are available to interface with the customer. For this, the call center computer 131 has access to information, such as electronic records or a database, listing all the available order takers 132, the language capabilities of each, and routing information so that the customer 112 can be connected to a selected one of the order takers. The level of service for which the establishment has contracted is also taken into account at this stage. A particular order taker 134 is automatically assigned chosen based on the selected language and a direct voice connection is made with the customer 112 through the microphone/speaker at the drive-through window ordering point of the establishment 120. For this, the call center computer 131 is provided with logic to automatically assign a human order taker capable of taking the customer's order in the language in which the customer wishes to verbally place the order, and further to assist in establishing the voice connection.

In one embodiment, as the assigned order taker 134 greets the customer 112, a connection is made to the order entry software system in use by the establishment 120. This connection may be a direct link to the establishment's local or remote computer as a virtual terminal or it could be through a copy of the order entry software located at the call center computer. In either case, the order entry screen is made available electronically to the assigned order taker 134 to take the order. Restaurant-specific information such as sale items, special offerings, inventory considerations and time-to-prepare may also be reflected in the screen that the assigned order taker 134 sees. Thus, the assigned order taker 134 is able to see the same items on his or her computer screen as those viewed by the customer 112 and thus can see the selections, prices and deals presented to the customer 112. The assigned order taker 134 may also have the ability to re-initiate the selection process in the event of a poor connection or a customer language mistake.

Once the customer 112 and the assigned order taker 134 are connected, a normal order entry dialogue takes place. Scripting, or “push” sales may be employed at the request of the establishment 120. As the order is completed, the assigned order taker 134 repeats the order to the customer 112 and verifies each item and the total price and then terminates the session once the assigned order taker 134 determines that the customer 112 has successfully completed the order. The assigned order taker 134 thus provides the establishment 120 with customer's order where it is made available to the order fillers and/or cashiers. The assigned order taker 134 also tells the customer 112 the total price and may also verbally instruct the customer 112 to drive forward to pick up and pay for the order. Payment will occur at the normal pay station with whatever form of currency, credit or debit card is customary for the establishment to accept.

Microphone/speaker units or terminals may be available at the pay station and at the point of food delivery in case there are any further questions by the customer 112. The food server/money taker may initiate communication with the call center 130 using the order number to present the appropriate screen to an appropriate order taker who may or may not be the same person as the assigned order taker 134 who took the customer's order.

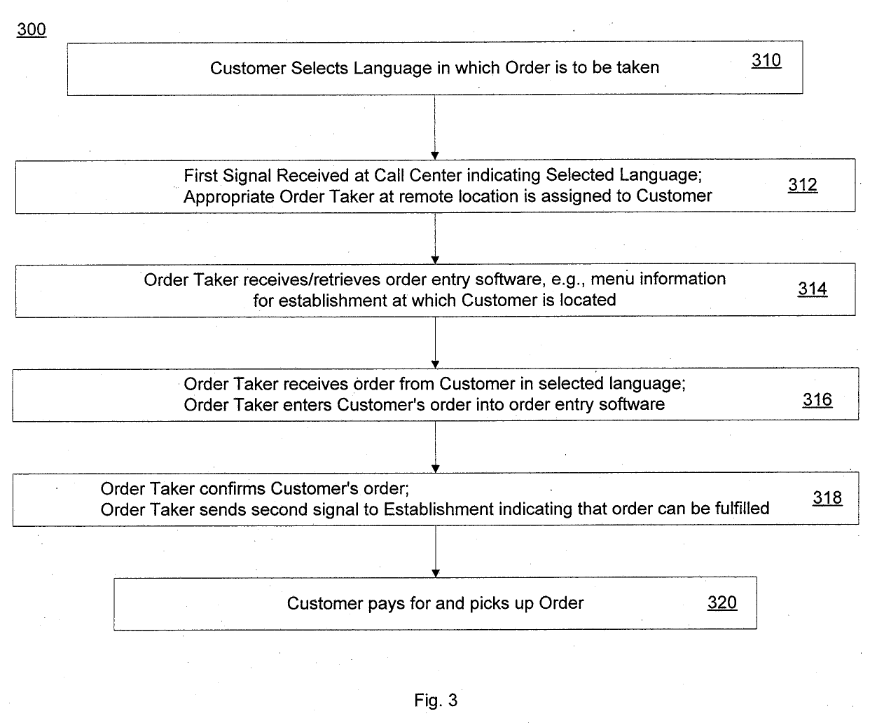

FIG. 3 shows a flow chart 300 depicting an overall method in accordance with the embodiment shown in FIG. 1. In step 310, the customer selects the language in which he or she wishes to place an order. In step 312, a first signal, preferably in the form of one or more data packets, is received at the call center 130 and an appropriate order taker is assigned to take the customer's order. In step 314, the assigned order taker gains access to the order entry software including information about the menu at the establishment at which the customer is located. In step 316, the assigned order taker takes the customer's order in the selected language and enters it. In step 318, the order taker confirms the customer's order and then sends a second signal back over the communication link 122 to the establishment 120 where the customer 112 is located. This second signal, also preferably in the form of one or more data packets, indicates that the order is complete and ready to be filled at the establishment 120. Finally, in step 320, the customer pays for picks up the order.

In one arrangement, the call center 130 and the establishment 120 are owned and/or operated by the same, or related legal entities. Thus, in one embodiment, the call center 130 is operated by the same company that operates the establishment 120. In another embodiment, the call center 130 is operated by a franchisor and the establishment 120 is operated by a franchisee. In another arrangement, the call center 130 is unrelated to the establishment 120, but merely provides the needed service of supplying order takers proficient in the languages offered to the customers of the establishment 120. Thus, such a call center 130 may service multiple establishments 120, 120A, 102B, 120C, all of which may not all belong to the same chain or even the same industry. Thus, it is possible that one or more establishments serviced by a single call center 130 require a first set of languages, while other establishments serviced by the same call center require a second set of languages, the first and second sets perhaps (but not necessarily) having languages in common. With either arrangement, an establishment is able to outsource its person-to-person order taking interface with a service that is available up to 24 hours per day and provides personnel able to converse with a customer in a language of the customer's choice. This can be advantageous to a business that has difficulty staffing such positions with reliable, well-trained and courteous employees.

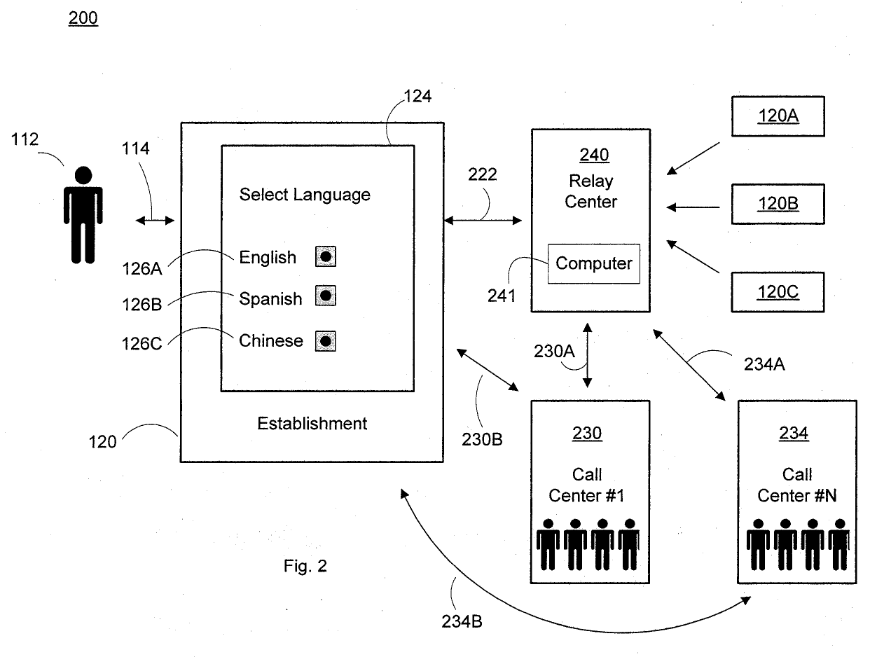

FIG. 2 shows a second embodiment of a system 200 in accordance with the present invention. The same reference numerals appearing in the embodiment of FIG. 1 refer to corresponding entities in the system 200. In system 200, the establishment 120 has a first link 222 with a relay center 240, and other establishments 120A, 120B, 120C may also communicate with the relay center 240. The relay center 240 is configured to selectively transfer the connection from the establishment 120 to one of a plurality of call centers 230, 234 via communication links 230A, 234A, respectively. The relay center 240 and the call centers 230, 234 may be operated by a common enterprise that provides customer ordering services to the enterprise's business clients. It is further understood that the relay center 240 may be co-located with one of the call centers 230, 234, though this is not a requirement. In general, the call centers 230, 234 can be located centrally or dispersed across the nation or globe to achieve desired business and operational objectives of the entity providing the service. While only two call centers are shown, it is understood that three, four or even more such call centers may be established.

At the relay center 240, the first signal is present to a relay center computer 241. The relay center computer 241 parses the signal into its components and various checks are made to validate the signal. Such checks may include encryption and data integrity codes as well as looking up the defined level of service available to that establishment at that time. Once cleared as a valid request, the relay center computer then looks up the available resources (i.e., other idle order takers conversant in the selected language among the various call centers 230, 234) to respond to the customer. For this, the relay center computer 241 has access to information, such as electronic records or a database, listing all the available order takers, the language capabilities of each order taker, the call center at which each order taker is located, and routing information so that the customer 112 can be connected to a selected one of the order takers. The relay center computer 241 is thus provided with logic to automatically assign a human order taker capable of taking the customer's order in the language in which the customer wishes to verbally place the order, and further to assist in establishing the voice connection.

In addition to the foregoing, the relay center computer 241 may have access to information about the level of services for which the establishment has contracted—e.g., mix of languages to be provided for that establishment, acceptable delay in connecting the customer to a human proficient in the language and even the acceptable proficiency levels of the humans who are to speak with the customers.

Using common statistical techniques to load-balance the system, an order taker is automatically selected to match the desired language. A direct voice communication link 230B or 234B is then established between the chosen call center 230 or 234, respectively, with the customer 112 through the microphone/speaker at the drive-through window ordering point of the establishment 120.

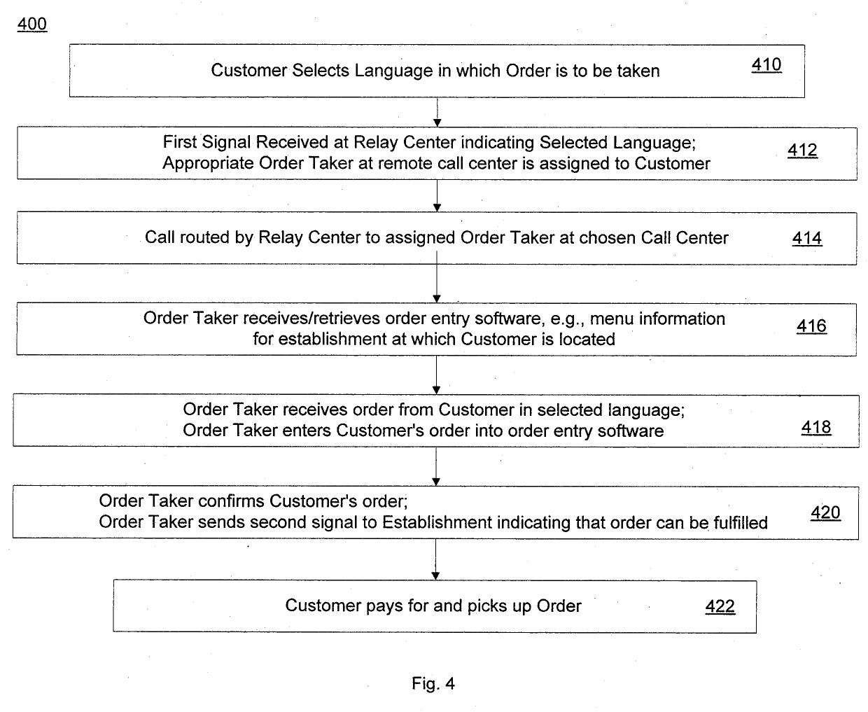

FIG. 4 shows a flow chart 400 depicting an overall method in accordance with the embodiment shown in FIG. 2. In step 410, the customer selects the language in which he or she wishes to place an order. In step 412, a first signal, preferably in the form of one or more data packets, is received at the relay center 240 and an appropriate order at one of the call centers taker is assigned to take the customer's order. In step 414, the communication link is routed from the relay center to the chosen call center at which the assigned order taker is located. In step 416, the assigned order taker gains access to the order entry software including information about the menu at the establishment at which the customer is located. In step 418, the assigned order taker takes the customer's order in the selected language and enters it. In step 420, the order taker confirms the customer's order and then sends a second signal back over the communication link to the establishment 120 where the customer 112 is located. This second signal, also preferably in the form of one or more data packets, indicates that the order is complete and ready to be filled at the establishment 120. Finally, in step 422, the customer pays for picks up the order.

To add entertainment value to the customer's experience, in addition to language selection, the customer 112 may further be asked to specify a famous individual who is to take the customer's order. The voices of these famous individuals would be provided by order takers who are able to impersonate one or more famous voices. Thus, well-recognized voices of humans, movie or television characters, cartoon characters, and even computer generated voices may be mimicked to enhance the customer experience. If, for example, English is the language selected by the customer 112, the customer may then be asked whether they would like Mickey Mouse, The Godfather, or Elvis to take their order. Upon selecting one of these choices, the customer 112 is connected to an order taker who is able to impersonate the selected individual. To implement such a feature, the computers 131, 241 are preferably provided with information on the impersonations that each available order taker can perform. This information is sent to the establishment 120 so that only those famous individuals whose voices the current set of available order takers can mimic are offered to customers. A signal from the establishment 120 received by the computer 131, 241 indicates the customer's famous voice preference, and the computer 131, 241 connects the customer 112 to the appropriate order taker in response thereto. It is understood that if such a feature is included, appropriate disclaimers may need to be presented to the customer, and appropriate licenses may need to obtained by the entity providing the service.

In the embodiments described thus far, the customer initiates the transaction by first pushing a button to indicate the desired language, and the system connects the customer to an order taker qualified to take an order in the selected language. However, other initiating events may instead be employed by the customer 112. For instance, in one embodiment, the customer first converses with an initial order taker in the common language of the geographical area. This initial order taker asks the customer for the latter's choice of language. If the initial order taker is not suitably conversant in the language preferred by the customer, the initial order taker transfers the call to the call center 130 where an order taker qualified to take orders in the selected language in assigned to the customer. In still other embodiments, the customer initiates the transaction by simply speaking the name of the selected language to a voice-recognition application, or by swiping a card having associated therewith magnetic, optical or other media coded with information reflective of the customer's native language.

In some embodiments, a default language will be used. If the customer wishes to use the default language, the customer may simply start speaking to an order taker without having to press a button. In such an instance, the customer is automatically connected to an order taker qualified to take an order in that default language. The default language may be determined by the geographical location of the establishment. The geographical location may be an entire country, or a state or province within the country, or even a city. For instance, in most locations in the United States, the default language is English. However, in certain locations within the United States, the default language may be Spanish or some other foreign language. In other countries, the default language will be based on whatever the dominant language happens to be in a particular geographical location. Thus, in China, for example, the default language might be Mandarin in a city such as Beijing, while it might be Cantonese in Guangzhou and much of Guangdong province. Furthermore, in some geographical locations, the selections may be made from a plurality of dialects. In other geographical locations, the selections may be made from a plurality of accents, to help a customer better communicate with an order taker.

Since the method and system described above effectively extend the establishment's point of sale system by adding a virtual order station, it is also possible to place one or more such interfaces 124 at an indoor counter. Thus, a customer may be able to take advantage of the benefits of such a system even in a non-drive-thru setting.

While the invention has been described thus far with respect to an embodiment in which the establishment is a fast food restaurant, it is understood that the establishment may be any kind of entity and the setting any one in which a customer verbally interacts with a live person acting on behalf of that entity. The central features of the invention described thus far, however, are that (1) the customer is offered a choice of languages in which to verbally interact with that live person, and (2) the live person is physically removed from the entity. Furthermore, in a preferred embodiment, the communication link is facilitated by VOIP. Thus, the described method and system may have utility in other situations such as, but not limited to banks, tourist attractions, hotels, concierge services, airports, hospitals (both in care giving as well as billing, benefits and cashier functions), or wherever real-time, customer initiated access to a human voice in the customer's desired language is of value. In each of these instances, the customer would be transferred to a human customer service agent who is situated at a location away from the establishment and is proficient in the language selected by the customer. The customer may then make any kind of verbal request, such as asking a question or making a request for information, materials, services, goods, and the like.

In addition, a system in accordance with the present invention may find use in an on-line chat environment in which a customer may select the language in which the customer desires to continue the dialog by voice. The establishment visited by the customer in this instance is a web site. In such case, one or more buttons on a computer screen may allow a customer to select his or her language of choice, perhaps via a tab, a pull-down menu, and/or other typical user interface which permits one to select from among a number of options. In such an online chat setting, once the connection is made, the customer service representative can take verbal orders for services or merchandise, help diagnose equipment at the customer's premises, provide information, and perform other tasks, as well.

It should be evident that the foregoing description is applicable to a business that is established to provide a customer-interface service to business customers. The service would allow such business customers to outsource their person-to-person interface with a customer-interface service that is available up to 24 hours per day, and that provides speakers conversant in languages selected by customers of those business customers. This can be advantageous to such business customers who have difficulty staffing such positions with reliable, well-trained and courteous employees.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method for taking an order from a customer visiting an establishment, the order being verbally placed by the customer in a language of the customer's choice, the method comprising:
receiving a first signal containing information reflective of a language in which the customer wishes to verbally place the order;
connecting the customer to a human order taker situated at a location away from the establishment, the human order taker being proficient in said language in which the customer wishes to verbally place the order; and
converting the customer's verbal order into an electronic order and providing the electronic order to the establishment.

2. The method according to claim 1, comprising:
presenting the customer with a choice of languages in which the customer may verbally place an order and receiving input from the customer reflective of the customer's language selection, prior to connecting the customer to a human order taker proficient in the selected language.

3. The method according to claim 1, comprising connecting the customer to the human order taker via the internet.

4. The method according to claim 3, comprising connecting the customer to the human order taker via the internet using voice-over-internet protocol (VoIP).

5. The method according to claim 1, comprising determining a level of service for which the establishment has contracted, prior to connecting the customer to the human order taker.

6. The method according to claim 1, comprising:
receiving the first signal at a relay center; and
determining to which of a plurality of call centers the customer should be connected, based on:
the language in which the customer wishes to verbally place the order; and
the availability of a human order taker proficient in said language.

7. The method according to claim 6, further comprising:
connecting the customer to a human order taker based on the result of said determining step.

8. The method according to claim 1, wherein said first signal is initiated by a customer at a drive-thru.

9. The method according to claim 1, further comprising:
receiving information reflective of a famous individual with whom the customer wishes to verbally place the order; and
connecting the customer to a human order taker who is able to mimic the voice of the famous individual with whom the customer wishes to verbally place the order.

10. A customer-selected-language verbal ordering system comprising:
a first center configured to receive a first signal containing information reflective of a language in which a customer visiting an establishment wishes to verbally place an order to obtain goods or services;
the first center including a first computer having access to information comprising available human order takers situated in locations away from the establishment, language capabilities of each order taker, and routing information sufficient to establish a voice connection between the customer and a selected human order taker;
the first computer further being provided with logic to automatically assign a human order taker capable of taking the customer's order in said language in which the customer wishes to verbally place the order.

11. The customer-selected-language ordering system according to claim 10, wherein the first computer is provided with information reflective of a level of service for which said establishment has contracted.

12. The customer-selected-language ordering system according to claim 10, wherein:
the first center comprises a relay center; and
the available human order takers are located in a plurality of call centers that are located away from the establishment.

13. The customer-selected-language ordering system according to claim 12, wherein:
the relay center is co-located with at least one of said plurality of call centers.

14. A method for verbally communicating with a customer who is visiting an establishment and wishes to make a verbal request in a language of the customer's choice, the method comprising:
receiving a first electronic signal containing information reflective of a language in which the customer wishes to communicate;
connecting the customer to a human customer service agent situated at a location away from the establishment, the human customer service agent being proficient in said language in which the customer wishes to make the verbal request.

15. The method according to claim 14, wherein the customer visits an establishment to place a verbal order for at least one of goods and services, further comprising:
converting the customer's verbal order into an electronic order and providing the electronic order to the establishment.

16. The method according to claim 14, further comprising:
presenting the customer with a choice of languages in which the customer may make a verbal request and receiving input from the customer reflective of the customer's language selection, prior to connecting the customer to the human customer service agent proficient in the selected language.

17. The method according to claim 14, comprising connecting the human customer service agent via the internet.

18. The method according to claim 17, comprising connecting the customer to the human customer service agent via the internet using voice-over-internet protocol (VoIP).

19. The method according to claim 14, comprising determining a level of service for which the establishment has contracted, prior to connecting the customer to the human customer service agent.

20. The method according to claim 14, comprising:
receiving the first signal at a relay center; and
determining to which of a plurality of call centers the customer should be connected, based on:
the language in which the customer wishes to make the verbal request; and
the availability of a human customer service agent proficient in said language.

21. The method according to claim 20, further comprising:
connecting the customer to a human customer service agent based on the result of said determining step.

22. The method according to claim 20, further comprising:
receiving information reflective of a famous individual with whom the customer wishes to make the verbal request; and
connecting the customer to a human customer service agent who is able to mimic the voice of the famous individual with whom the customer wishes to make the verbal request.
